(19) United States
(12) Patent Application Publication
(10) Pub. No.: US 2012/0223969 A1
(43) Pub. Date: Sep. 6, 2012

(54) DEVICE FOR CAPTURING AND DISPLAYING IMAGES OF OBJECTS, IN PARTICULAR DIGITAL BINOCULARS, DIGITAL CAMERA OR DIGITAL VIDEO CAMERA

(75) Inventors: Martin Schoeller, Niederpocking (DE); Heinz Oster, Starnberg (DE)

(73) Assignee: SCHOELLER HOLDING GMBH, Pullach (DE)

(21) Appl. No.: 13/510,886

(22) PCT Filed: Nov. 19, 2010
(86) PCT No.: PCT/EP2010/007049

§ 371 Date: May 18, 2012

(30) Foreign Application Priority Data
Nov. 19, 2009 (DE) 10 2009 054 000.8

(51) Int. Cl. G09G 5/00

(52) U.S. Cl. 345/633

(57) ABSTRACT

The invention relates to a device for capturing and displaying images of objects, in particular digital binoculars (1), a digital camera (14) or a digital video camera, the device comprising: a digital storage medium (24, 27) including a database, which includes elements including meta information (10, 20) for objects, in particular geographic data and/or names of a landscape, a mountain range or a building or names of plants or animals; a comparison device (33); and a superposition device (34) for superimposing meta information (10, 20) selected by the comparison device (33) as a function of the objects captured in image capture devices (2, 15) into image display devices (3, 16). The invention further relates to a method for capturing and displaying an image from such a device.

The invention relates to a device for capturing and displaying images of objects, in particular digital binoculars, a digital camera or a digital video camera. The invention furthermore relates to a method for capturing and displaying an image of a device.

Digital cameras and digital video cameras have many functions and options to capture images and videos in very good quality. Among them are e.g. an automatic focus or exposure times and apertures which adjust to the environment. In order to perform adjustments for portrait pictures, landscape pictures or night pictures, etc., a digital menu is provided that can be operated by the user through push buttons provided at the camera and which is superimposed onto the actual image in the display of the device.

It is an advantage of modern digital cameras or digital video cameras over conventional devices that the camera can store capture parameters like e.g. the date and the time, the focus and aperture setting, the exposure time, flash and a thumbnail image. For this purpose, a plurality of file formats has been developed and almost all modern digital cameras are capable of operating according to the Exif-standard.

It is the object of the present invention to provide a device for capturing and displaying images of objects which provides a broader functionality.

The object is achieved through a device for capturing and displaying images of objects with the features according to patent claim 1.

It is the core idea of the invention to provide a device for capturing and displaying images of objects, in particular digital binoculars, a digital camera or a digital video camera including image capture devices and image display devices which includes a digital storage medium with a database with elements with meta information regarding objects and a comparison device and a superposition device for meta information selected by the comparison device as a function of objects captured in the image capture devices into the image display devices.

It is an advantage of the invention that meta information of a captured object is actually provided in real time and superimposed with the real picture of the object.

For images of landscapes, mountains, buildings or similar target objects, the meta information includes the designation of the captured object like e.g. “Zugspitze” or also geographic data. In images of plants of animals, the meta information includes in particular the designation of the captured object.

Advantageous embodiments of the invention are characterized by the features recited in the dependent claims.

In one embodiment of the invention, the comparison device includes a determination device which receives an image of the object from the image capture devices and determines structural information regarding the object like e.g. contours of the object and/or features regarding the property of the object from the received image of the object.

In one embodiment of the invention the comparison device performs a comparison of structure information of the captured object with elements of the database and in case a comparison shows coincidence, thus when an object was identified passes on at least a meta information regarding the identified object to the superposition device.

In one embodiment of the invention, the database with the meta information or a portion of the database with the meta information is stored on a storage medium in the device.

In one embodiment of the invention, the device includes an interface, in particular a card reader for connecting an external digital storage medium. In order to be able to individually adjust the size of the memory to the user, it is advantageous when the database with the meta information is at least partially stored on the replaceable storage medium.

In one embodiment of the invention, the device includes a flash memory, wherein the comparison device stores an identified element from the database in the flash memory and keeps it stored in the flash memory. When performing the comparison, preferably initially the elements from the flash memory are compared with the structure information of the real image.

In one embodiment of the invention, the device includes a GPS device or a connection for an external GPS device. This way, an identification of objects can be facilitated through GPS data. Advantageously also coordinates for locating the image can be added to the image as additional meta information, wherein the coordinates are put out on the image display devices and/or can be stored together with the image.

In one embodiment of the invention, the device includes remote data transfer devices, in particular an internet connection. Thus, the unit includes a device for establishing an internet connection and for terminating an internet connection. The comparison device can transmit the determined structural information regarding the captured object or the real image to a software through an internet server, wherein the software determines the structure information from the real image and/or performs the comparison of the determined structure information regarding the object with elements from a database on the internet server.

In one embodiment of the invention, the unit includes devices for establishing and terminating a mobile radio connection. Thus, a GPS position determination through A-GPS can be performed through mobile radio detection. Certainly, the mobile radio connection can also be used for communications with an internet server.

In one embodiment of the invention, the unit includes devices for storing images and one device stores the captured images together with meta information regarding the identified object in a memory of the unit or on a memory card, e.g. in the Exif format or in the DCF format, in the IPTC format or in the XMP format. The stored meta information facilitates the subsequent organization and manipulation of the images and videos on a PC.

In one embodiment of the invention, the comparison device is stored in the unit on a chip and is executed by a data processing device.

In one embodiment of the invention, the comparison device includes software for people recognition and fingerprint comparison.

The invention furthermore provides a method for capturing and displaying an image of a unit, in particular a pair of digital binoculars, a digital camera or a digital video camera.

The method according to the invention thus includes the steps:
Capturing an image of an object, in particular of a landscape, a mountain, a building, a plant or an animal;

Determining structural information regarding the captured object, like e.g. contours of the object and/or features regarding the properties of the object;

Comparing the determined structural information regarding the captured object with elements from a database including elements which include meta information regarding objects like designations and/or geographic data;

Retrieving at least one predetermined meta information regarding the identified object from the database in case a comparison matches;

Forwarding the meta information from the database to image display devices; and

Superimposing the captured object with the captured image on the image display devices.

In one embodiment of the invention, the method includes superimposing the meta information in the form of text at a predetermined and fixated location on the image display devices.

In an alternative embodiment of the invention, the method includes superimposing the meta information in form of text on the identified object or proximal to the identified object on image display devices.

In one embodiment of the invention, the method includes a permanent superposition of the meta information from the database regarding the identified object so that the meta information configured as a text moves with the object on the putout image when the camera moves or the object moves.

In one embodiment of the invention, the method includes storing the identified element of the database in a flash memory. The element from the database for an object once identified is thus provided permanently, in particular until the unit is turned off.

In one embodiment of the invention, the method includes storing the putout image, wherein the meta information from the database is being stored as well.

In one embodiment of the invention, the method includes establishing and terminating an internet connection and determining and/or comparing structure information of the real image with elements of the database on a powerful internet server.

Subsequently preferred embodiments of the unit according the invention and of the method according to the invention are described with reference to the appended drawing figures in order to describe further essential features of the invention, wherein:

FIG. 1 illustrates a first embodiment of a device according to the invention, with an example of an image output;

FIG. 2 illustrates a second embodiment of a device according to the invention, with another embodiment of an image output; and

FIG. 3 illustrates a block diagram according to an embodiment of a device according to the invention.

As evident from FIG. 1, a first embodiment of the device according to the invention relates to a pair of digital binoculars, which includes image capture devices 2 configured as a lens system. A binocular embodiment is illustrated, but the invention is not limited thereto and can also relate to a monocular telescope. The digital binoculars 1 include image display devices 3 which are configured as oculars which a viewer directly applies to the eyes through rubber coated eye shells 4. The digital binocular 1 includes an input device 5 configured as push buttons 6.

A mountain scene 8 with a mountain 9 is illustrated as an embodiment of an image output 7 of the digital binoculars 1 displayed on the image display devices 3, wherein the mountain landscape is targeted with the digital binoculars 1. On the image display devices 3, meta information 10 regarding the mountain 9 are superimposed with the mountain landscape 8, in this case the designation and the height of the mountain 9. The meta information 10 is displayed at a fixated location, thus in an exemplary manner at the lower edge of the image output 7 so that the view of the viewer of the mountain 9 is not impaired.

In a particularly advantageous manner, the invention is applicable in tourism applications as can be illustrated with reference to the mountain landscape 8. The tourist is located in a particular region, thus e.g. in the Alps and targets his digital binoculars 1 at the mountain 9. The digital binoculars 1 superimpose the name of the mountain 9 which can thus be used for orientation and information purposes and optionally additional information like e.g. the height of the mountain, name of the mountain range and similar.

In the embodiment according to FIG. 1, a determination device of the digital binoculars determines the horizon 11, this means the borderline of the mountain landscape 8 with respect to the sky 12 and thus determines a mountain silhouette 13, namely the portion of the mountain 9 which is simultaneously a portion of the horizon 11. The mountain silhouette 13 has a particular geometric shape, thus the upward protruding mountain peaks typical for the mountain 9.

Subsequently, the mountain silhouette 13 is compared with elements from a database with mountain silhouettes by a comparison device of the digital binoculars 1. The database receives meta information regarding mountain silhouettes in association with the mountain silhouettes like designations and/or geographic data.

In case of a so-called matching of an element of the database with the mountain silhouette 13, thus when a mountain was identified onto which the silhouette fits, a superposition device of the digital binoculars 1 superimposes the meta information 10 regarding the mountain 9 into the real image. The comparison device furthermore stores the meta information 10 in a flash memory so that they are continuously provided in the superposition device.

Through a GPS device of the digital binocular 1 according to an embodiment of the invention coordinates of the location can already be provided where the tourist is located. The search in the database can thus be limited to the elements which are located in a particular radius about the respective coordinates. Put differently, the search for the mountain 9 can be limited to mountains according to the GPS data which are visible at all from the location where the tourist is located.

A second embodiment of the device according to the invention relates to a digital camera 14 illustrated in FIG. 2. The digital camera 14 includes image capture devices 15 which are configured as a lens system with a zoom function and a CCD camera. The digital camera 14 furthermore includes image display devices 16 which are configured as a display on the backside of the digital camera 14 (not illustrated). A user has the option through an input device 17 to perform the usual adjustments in the digital camera 14. Thus, as it is known in the art, a menu is superimposed on the display on which e.g. settings for exposure times, flashing, capture modes for the image like particular settings for portraits, night pictures or similar can be performed.

An image of a plant 19 is represented as an embodiment of an image output 18 of the digital camera 14, wherein the plant was identified through a comparison device and its name is superimposed on the image display devices 16 as meta information 20 proximal to the plant 19. At the left edge furthermore typical menu settings 21 are visible, thus e.g. settings for exposure time and flash which are also superimposed with the real image of the plant 19.

Determining the structure information and determining the meta information 20 of the plant 19 can be performed substantially like for the mountain panorama 8 in FIG. 1. As an alternative thereto, the comparison device can send the determined structure information for the plant 19 to an internet server which compares them with elements from a database on the internet server in which data for the plant is stored. In an alternative embodiment, the comparison device transmits the real image in its entirety and also the determination of the structure information is performed on the internet server. The internet server sends the meta information to the comparison device in case there is a matching.

In the embodiment according to FIG. 2, the determined structure information regarding the plant 19 is used again in order to state the name of the plant 19 on the image display devices 16 proximal to the plant 19. The comparison device thus recognizes an outer contour 22 of the plant 19 and arranges the name outside of the identified outer contour 22 of the plant 19.

Since the user typically moves with the digital camera 14 or with the digital binocular 1, while he points towards the object, in case the meta information 10, 20 is put out on the image display devices 3, 16 proximal to the object or on the object, an appropriate image display frequency is defined for the superimposed meta information 10, 20, e.g. between 0.1 and 2 seconds. This way, camera shakes which could cause the text to become unreadable for the user can be averaged out.

Certainly the type of displaying the meta information 10, 20 is independent from which objects are being identified and in the plant example the meta information 20 regarding the plant 19 can be arranged at the image display devices 16 at a fixed location, e.g. at a lower edge of the display and for the mountain example, the meta information 10 can be arranged on the mountain or proximally to the mountain 9.

Other embodiments of the invention relate to databases with predetermined data for buildings like e.g. churches or towns or also artifacts, car types or animals can be identified in the described manner. Thus e.g. significant buildings from a particular town or from a particular region can be stored on a memory card of the device which is inserted into the device in case of mountain regions or mountains, e.g. eastern Alps, western Alps or similar, in case of plants or animals, thus western European or eastern European plants or animals and similar.

The device according to the invention includes additional components which are not visible in FIGS. 1 and 2 and which are subsequently described in more detail with reference to the block diagram in FIG. 3. Like reference numerals are used for components with like functions.

The device includes image processing devices 23. These are in particular devices to make the image more discrete, this means devices for converting the light intensities into analog electrical signals in discrete elements and devices for digitizing, this means devices for analog-digital conversion of the signals which is also designated as quantification. The image processing devices 23 can be configured so that they process captured images through additional sensors like e.g. infrared sensors.

Furthermore, the device includes an internal storage medium 24 which among other things is used for storing the captured images and an import-/export-interface 25, e.g. a USB connection or a bluetooth transceiver through which stored images can be transferred to a PC and/or software updates can be performed.

The reference numeral 26 designates an interface for an external digital storage medium 27 which can be captured by the device. The external digital storage medium can be e.g. an exchangeable CDROM or a memory card in particular of the types CF, MS, MMC, SD, XM, xD. It is appreciated that the unit in this case includes a card reader or a CDROM reading unit to read the external digital storage medium 27.

On the external digital storage medium 27 and/or on the device internal storage medium 24, databases with database elements are stored. Among other things the database elements include the meta information 10, 20 regarding particular objects. Beyond that, a flash memory 28, in particular a cache memory is provided in which data can be stored and from which data can be read.

Furthermore, a GPS device including a signal receiving unit 29 for receiving a GPS signal and a position determination unit 30 which processes a GPS signal received by the signal receiving unit 29 and which computes the current position of the device are provided.

The device furthermore includes a radio/internet interface 31, e.g. an access to a mobile radio network. The radio-/internet-interface 31 can be configured as bidirectional communication link with a powerful internet server.

Through the radio-/internet-interface 31, a device of the unit can connect with an internet server, download a database and write it into the memory 24. Thus, the user can select and control the downloads through a menu depicted on the image display devices 3, 16 through the input device 5, 17.

Furthermore, a data processing device 32 is arranged in the device. Software for the data processing device 32 includes in particular a comparison device 33 and a superposition device 34 and is stored on a chip in the device.

Subsequently, features of the software according to the invention on the data processing device 32 are being described.

The software initially includes the conventional digital menu of the unit and controls the particular components of the unit, namely the image capture devices 2, 15, the image processing devices 23, the GPS device 29, 30, the radio-/internet-interface 31, the importing-/exporting-interface 25 and the access to the storage media 24, 27, 28. Additionally, the software handles the inputs by the user.

A real image captured by the image capture devices 2, 15 is processed by the image processing devices 23 connected subsequent to the image capture devices 2, 15 and the real image is transferred through the superposition device 34 to the image display devices 3, 16. The unit according to the invention facilitates a typical capture and output of the real image as known in the art. The superposition device 34 can also superimpose the user menu over the real image. Also the current coordinates of the unit determined by the GPS device 29, 30 and/or location names can be put out by the superposition device 34 on the image display devices 3, 16. The superposition device 34 can respectively control the transparency of the superposition through a so-called channel control, so that the real image can shine through the superpositions.

The real images captured or received by the device are processed by the data processing device 32 and transmitted for this purpose to the comparison device 33 after digitizing. The comparison device includes a determination device which includes tools for biometric people recognition and for fingerprint identification.

The determination device determines structure information regarding the objects on the real image from the received real image, like e.g. outer contours and/or particular features regarding the properties of objects. This can be performed e.g. in that contrasts, brightness differences, color ranges and/or color changes are considered and/or complex computations like a wavelength analysis or a main component analysis are performed on the digitized real image. It is essential that features regarding geometric arrangements, texture properties and/or shapes of an object are extracted from the real image. The object can subsequently be located in the image.

Thereafter, the comparison device 33 writes the determined structure features into a suitable data structure in order to facilitate access to the structure features and their use in an advantageous manner.

In order to determine what is illustrated in the image, the comparison device 33 compares the structural features written into the data structures with the elements of the database.

In case there is a match, the comparison device 33 stores an identified element from the database into the flash memory 28, so that the meta information 10, 20 regarding the identified element is provided permanently and quickly.

When an object is identified, the superposition device 34 superimposes the meta information 10, 20 from the database with the captured image. It is possible to control the transparency of the display of the meta information 10, 20 so that the real image shines through the meta information 10, 20. It is also possible that the meta information 10, 20 is only displayed upon particular request of the user.

1. Digital binoculars, a digital video camera for capturing and displaying images of objects, comprising:
a digital storage medium including a database, which includes elements including meta information for objects, in particular geographic data and/or names of a landscape, a mountain range or a building or names of plants or animals;
a comparison device; and
a superposition device for superimposing meta information selected by the comparison device as a function of the objects captured in image capture devices into image display devices.

2. The device according to claim 1, wherein the comparison device includes a determination device which receives an image of an object from the image capture devices and determines information regarding the object like e.g. contours of the object and/or features regarding the properties of the object from the received image of the object.

3. The device according to claim 1, wherein the comparison device performs a comparison of structure information of the captured object with elements of the database and in case of a match of a comparison passes on at least meta information regarding the identified object to the superposition device.

4. The device according to claim 1, wherein the unit includes an interface for connecting an external digital storage medium on which a database is stored.

5. The device according to claim 1, wherein the unit includes a flash memory.

6. The device according to claim 1, wherein the device includes a GPS device or a connection for an internal GPS device.

7. The device according to claim 1, wherein the devices includes remote data transmission devices, in particular an internet connection, and the device includes a device for establishing an internet connection and for terminating an internet connection with an internet server.

8. The device according to claim 1, wherein the device includes devices for establishing and terminating a mobile radio link.

9. The device according to claim 1, wherein the device includes devices for storing images together with the meta information.

10. The device according to claim 1, wherein the comparison device is stored in the device as software on a chip and is executed through a data processing device.

11. The device according to claim 10, wherein the comparison device includes software for people recognition or fingerprint comparison.

12. A method for capturing and displaying an image through a pair of digital binoculars or a digital video camera comprising the steps:
capturing an image of an object, in particular of a landscape, a mountain, a building, a plant or an animal;
determining structural information regarding the captured object, like e.g. contours of the object and/or features regarding the properties of the object;
comparing the determined structure information regarding the captured object with elements from a database including elements which include meta information regarding objects like designations and/or geographic data;
retrieving predetermined meta information regarding the identified object from the database in case a comparison matches;
forwarding the meta information from the database to image display devices; and
superimposing the captured object with the meta information on the image display device.

13. The method according to claim 12, further comprising the step: superimposing the meta information in the form of text at a particular location on the image display devices.

14. The method according to claim 12, further comprising superimposing the meta information in the form of text on the identified object or proximal to the identified object on the image display devices.

15. The method according to claim 12, further comprising the step: storing the identified element of the database in a flash memory so that the element from the database regarding a once identified object is permanently provided, in particular until the device is switched off.

16. The method according to claim 15, wherein the meta information is permanently provided from the database to the identified object so that the meta information as a text for a movement of the device or for a movement of the object move with the object on the put-out image.

17. The method according to claim 12, further comprising the step storing the put-out image, wherein the meta information of the identified object is also stored.

18. The method according to claim 12, further comprising the step establishing and terminating an internet connection and determining and/or comparing the structure information with elements of the database on a powerful internet server.
